(19) United States
(12) Patent Application Publication
(10) Pub. No.: US 2025/0353304 A1
(43) Pub. Date: Nov. 20, 2025

(54) SYSTEM AND LIQUID CONTAINER

(71) Applicant: BROTHER KOGYO KABUSHIKI KAISHA, Nagoya (JP)

(72) Inventors: Masahiro HAYASHI, Anjo (JP); Naoya OKAZAKI, Hashima (JP); Yuma TANABE, Nagoya (JP); Satoru OKI, Nagoya (JP); Yuji FUKUTA, Nagoya (JP)

(73) Assignee: BROTHER KOGYO KABUSHIKI KAISHA, Nagoya (JP)

(21) Appl. No.: 19/284,197

(22) Filed: Jul. 29, 2025

Related U.S. Application Data
(63) Continuation of application No. PCT/JP2024/002368, filed on Jan. 26, 2024.

(30) Foreign Application Priority Data
Jan. 31, 2023 (JP) 2023-012447

(51) Int. Cl. B41J 2/175

(52) U.S. Cl. CPC B41J 2/17523

(57) ABSTRACT

A system includes: a liquid container including a first storage chamber stores a recording liquid; and a tank including a second storage chamber stores the recording liquid. The liquid container is connected to the tank. The liquid container includes a first flow path part defines a first flow path connecting a first opening located inside the liquid container and a second opening located outside the first storage chamber, and a third opening communicates the first storage chamber with outside. The tank includes a second flow path part defines a second flow path connecting a fourth opening located in the second storage chamber and a fifth opening located outside the second storage chamber and is inserted into the first storage chamber through the third opening from the outside, and a sixth opening communicates the second storage chamber with the outside and is connected to the first flow path part.

### REFERENCE TO RELATED APPLICATIONS

This is a continuation application of International Application No. PCT/JP2024/002368 filed on Jan. 26, 2024, which claims priority from Japanese Patent Application No. 2023-012447 filed on Jan. 31, 2023. The entire contents of the aforementioned applications are incorporated herein by reference.

### BACKGROUND ART

There is a system including an ink bottle and an ink tank to which the ink bottle is connected. In the system, the ink tank has a needle implemented by a first flow path and a second flow path. The needle communicates inside and outside of the ink tank. In a connection posture in which the ink bottle is connected to the ink tank, the needle is inserted into the ink bottle. One of the first flow path and the second flow path functions as a flow path through which ink flows, and the other functions as a flow path through which air flows. In this way, the ink is injected into the ink tank by using air-liquid exchange in which the ink and the air move back and forth between the ink tank and the ink bottle.

In the above system, the bottle may include a nozzle having the first flow path and the second flow path.

In a system including an ink tank having a needle implemented by two flow paths, the needle is inserted into the ink bottle, and thus when the amount of ink in the ink bottle is reduced, a liquid surface of the ink tends to be lower than an opening end of the needle. Therefore, the ink is less likely to flow into the first flow path or the second flow path, and the ink is likely to remain inside the ink bottle.

On the other hand, in a system including a bottle having a nozzle implemented by two flow paths, the bottle has the first flow path and the second flow path, and thus even when the amount of ink in the bottle decreases, the ink easily flows into the first flow path or the second flow path. Therefore, the ink is less likely to remain inside the bottle. However, when the bottle is connected to the ink tank, both of the first flow path and the second flow path are likely to be submerged with the ink, and thus it is difficult to smoothly perform the air-liquid exchange in which the ink and air move back and forth between the bottle and the ink tank. Therefore, it is difficult to smoothly inject the ink from the bottle to the ink tank.

### SUMMARY

Therefore, there is a demand for a system and a liquid container in which a liquid is less likely to remain inside the liquid container and the liquid can be smoothly injected from the liquid container into a tank.

A system according to the present disclosure including: a liquid container including a first storage chamber configured to store a recording liquid; and a tank including a second storage chamber configured to store the recording liquid, the liquid container being connected to the tank. The liquid container includes a first flow path part that defines a first flow path connecting a first opening located inside the liquid container and a second opening located outside the first storage chamber, and a third opening that communicates the first storage chamber with outside. The tank includes a second flow path part that defines a second flow path connecting a fourth opening located in the second storage chamber and a fifth opening located outside the second storage chamber and is inserted into the first storage chamber through the third opening from the outside, and a sixth opening that communicates the second storage chamber with the outside and is connected to the first flow path part.

A liquid container according to the present disclosure connectable to a tank and capable of supplying a recording liquid to the tank, the liquid container including: a body configured to store the recording liquid; a first flow path part that communicates inside of the body with outside of the body and defines a first flow path connecting a first end opened to the inside and a second end opened to the outside; and a communication port that communicates the inside with the outside. The second end is located downstream of the communication port in a direction in which the first flow path part extends from the first end toward the second end.

### BRIEF DESCRIPTION OF THE DRAWINGS

FIG. 1A and FIG. 1B are external perspective views of a multi function device 10, in which FIG. 1A illustrates a state where a cover 70 is closed, and FIG. 1B illustrates a state where the cover 70 is opened.

FIG. 2 is a longitudinal sectional view schematically illustrating an internal structure of a printer unit 11.

FIG. 3 is a plan view illustrating arrangement of a carriage 23 and an ink tank 100.

FIG. 4 is a perspective view of an ink tank 100M.

FIG. 5 is a longitudinal sectional view of the ink tank 100M.

FIG. 6 is a perspective view of a liquid bottle 80.

FIG. 7 is an exploded perspective view of the liquid bottle 80.

FIG. 8 is a longitudinal sectional view of the liquid bottle 80 in a state where a valve 133 is located at a close position.

FIG. 9 is a longitudinal sectional view of the liquid bottle 80 in a state where the valve 133 is located at an open position.

FIG. 10 is a longitudinal sectional view illustrating a state where the liquid bottle 80 is connected to the ink tank 100M.

FIG. 11 is a longitudinal sectional view illustrating the liquid bottle 80 according to a modification in which a bottle body 81 and a bottle cap 82 are integrally formed.

FIG. 12 is a longitudinal sectional view illustrating the liquid bottle 80 according to a modification in which the valve 133 is omitted.

FIG. 13 is a longitudinal sectional view illustrating a state where the liquid bottle 80 according to a modification is connected to the ink tank 100M.

FIG. 14 is a sectional view taken along a line XIV-XIV of FIG. 13.

FIG. 15 is a sectional view illustrating a state where the liquid bottle 80 is connected to the ink tank 100M according to a modification.

### DESCRIPTION

Hereinafter, an embodiment will be described. The embodiment to be described below is merely an example of the present disclosure, and it is needless to say that the embodiment of the present disclosure can be appropriately modified without departing from the gist of the present disclosure. In addition, in the following description, advancement from a start point to an end point of an arrow is expressed as an orientation, and movement on a line connecting the start point and the end point of the arrow is expressed as a direction. That is, the orientation is a component of the direction. An upward orientation and a downward orientation are components of an up-down direction 7 and are opposite orientations. A leftward orientation and a rightward orientation are components of a left-right direction 9 and are opposite orientations. A frontward orientation and a rearward orientation are components of a front-rear direction 8 and are opposite orientations. In the present embodiment, the up-down direction 7 corresponds to a gravity direction, and the front-rear direction 8 and the left-right direction 9 correspond to a horizontal direction.

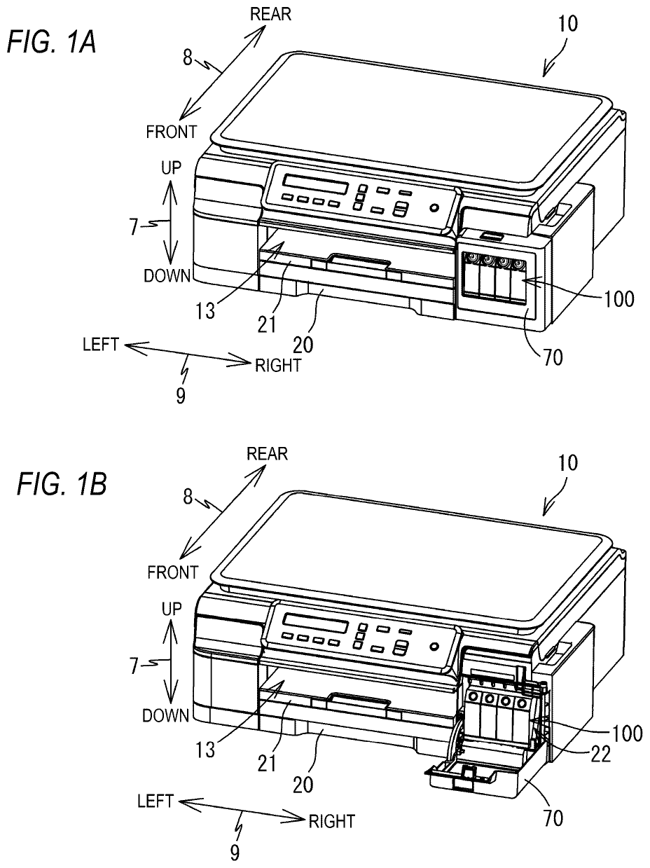

Further, the up-down direction 7 is defined based on a state where a multi function device 10 (example of system) is installed in a usable manner (state of FIGS. 1A and 1B, which may be referred to as “use state”) or a posture (posture of FIGS. 1A and 1B, which may be referred to as “use posture”), the front-rear direction 8 is defined with a side of the multi function device 10 on which an opening 13 is provided as a front side (front surface), and the left-right direction 9 is defined when the multi function device 10 is viewed from the front side (front surface).

### Overall Configuration of Multi Function Device 10

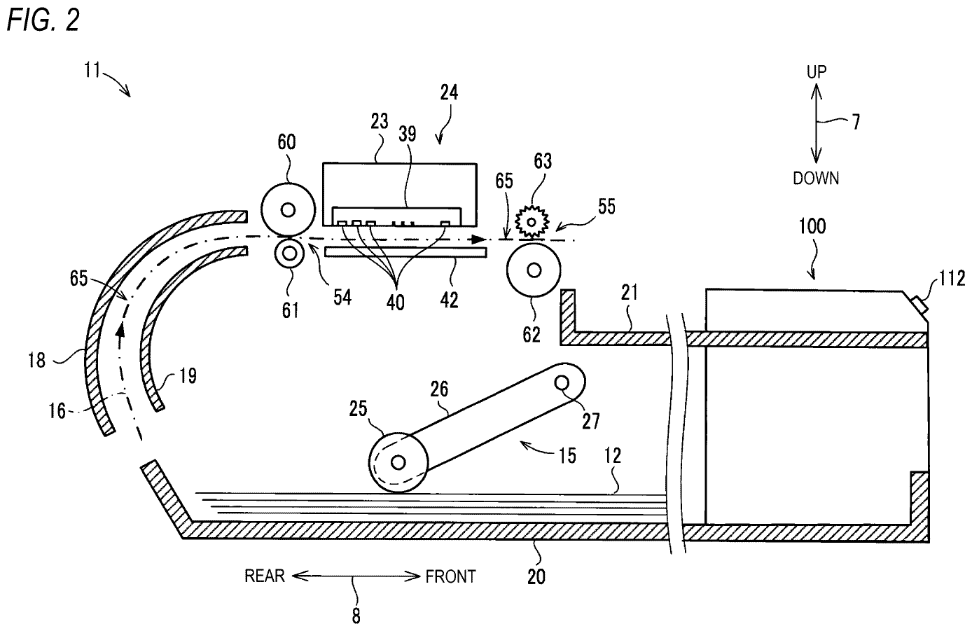

As illustrated in FIGS. 1A and 1B, an outer shape of the multi function device 10 is a substantially rectangular parallelepiped. The multi function device 10 includes a printer unit 11 and a liquid bottle 80 (example of liquid container) described later in a lower portion of a casing. The printer unit 11 records an image on a sheet 12 (see FIG. 2) by an inkjet recording method. As illustrated in FIG. 2, the printer unit 11 includes a feed unit 15, a feed tray 20, a discharge tray 21, a conveying roller part 54, a recording unit 24, a discharge roller part 55, a platen 42, and an ink tank 100 (example of tank). The multi function device 10 has various functions such as a facsimile function and a print function.

### Feed Tray 20 and Discharge Tray 21

As illustrated in FIGS. 1A and 1B, the opening 13 is located at a central portion in the left-right direction 9 on the front surface of the multi function device 10. The feed tray 20 moves in the front-rear direction 8 through the opening 13 by a user operation. The feed tray 20 supports a plurality of stacked sheets 12. The discharge tray 21 is located above the feed tray 20. The discharge tray 21 moves in the front-rear direction 8 together with the feed tray 20. The discharge tray 21 supports the sheet 12 discharged by the discharge roller part 55.

### Feed Unit 15

The feed unit 15 feeds the sheet 12 supported by the feed tray 20 to a conveying path 65. As illustrated in FIG. 2, the feed unit 15 includes a feed roller 25, a feed arm 26, and a shaft 27. The feed roller 25 is rotatably supported by a distal end portion of the feed arm 26. The feed roller 25 is rotated by a driving force of a conveying motor (not illustrated) in an orientation in which the sheet 12 is conveyed in a conveying orientation 16. Hereinafter, rotation of the feed roller 25, a conveying roller 60, and a discharge roller 62 in the orientation in which the sheet 12 is conveyed in the conveying orientation 16 is referred to as “forward rotation”. The feed arm 26 is rotatably supported by the shaft 27 supported by a frame of the printer unit 11. The feed arm 26 is biased to pivot toward the feed tray 20 by its own weight or an elastic force of a spring or the like.

### Conveying Path 65

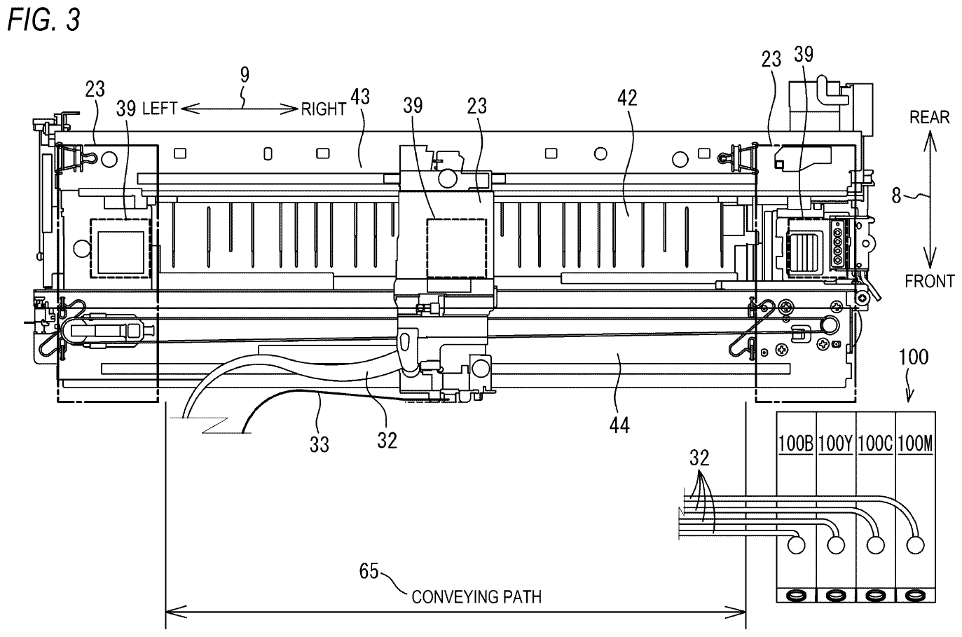

As illustrated in FIG. 2, the conveying path 65 is, for example, a space defined by an outer guide member 18 and an inner guide member 19 facing each other at a predetermined interval inside the printer unit 11. The conveying path 65 extends from a rear end portion of the feed tray 20 to a rear side of the printer unit 11. The conveying path 65 makes a U-turn while extending upward from below on the rear side of the printer unit 11, and reaches the discharge tray 21 through a space between the recording unit 24 and the platen 42. As illustrated in FIGS. 2 and 3, the conveying path 65 between the conveying roller part 54 and the discharge roller part 55 is located at a substantially central portion of the multi function device 10 in the left-right direction 9, and extends in the front-rear direction 8. The conveying orientation 16 of the sheet 12 in the conveying path 65 is indicated by a one-dot chain line arrow in FIG. 2.

### Conveying Roller Part 54

As illustrated in FIG. 2, the conveying roller part 54 is located upstream of the recording unit 24 in the conveying orientation 16. The conveying roller part 54 includes the conveying roller 60 and a pinch roller 61. The conveying roller 60 and the pinch roller 61 face each other in the up-down direction 7. The conveying roller 60 is rotated by the drive transmitted from the conveying motor. The pinch roller 61 rotates following the rotation of the conveying roller 60. When the conveying roller 60 is rotated forward by forward rotation of the conveying motor, the sheet 12 is conveyed in the conveying orientation 16 while being nipped by the conveying roller 60 and the pinch roller 61.

### Discharge Roller Part 55

As illustrated in FIG. 2, the discharge roller part 55 is located downstream of the recording unit 24 in the conveying orientation 16. The discharge roller part 55 includes the discharge roller 62 and a spur 63. The discharge roller 62 and the spur 63 face each other in the up-down direction 7. The discharge roller 62 is rotated by the drive transmitted from the conveying motor. The spur 63 rotates following the rotation of the discharge roller 62. When the discharge roller 62 rotates forward by the forward rotation of the conveying motor, the sheet 12 is conveyed in the conveying orientation 16 while being nipped by the discharge roller 62 and the spur 63.

### Recording Unit 24

As illustrated in FIG. 2, the recording unit 24 is located between the conveying roller part 54 and the discharge roller part 55 in the conveying orientation 16. The recording unit 24 faces the platen 42 in the up-down direction 7 with the conveying path 65 interposed therebetween. The recording unit 24 is located above the conveying path 65 in the up-down direction 7. The recording unit 24 includes a carriage 23 and a recording head 39.

As illustrated in FIG. 3, the carriage 23 is supported by guide rails 43 and 44. The guide rails 43 and 44 are supported by the frame of the printer unit 11. The guide rails 43 and 44 are spaced apart from each other in the front-rear direction 8 and extend in the left-right direction 9. The carriage 23 is coupled to a known belt mechanism provided on the guide rail 44. The belt mechanism is rotated by the drive transmitted from a carriage motor (not illustrated). When the belt mechanism rotates, the carriage 23 moves in the left-right direction 9. A movement range of the carriage 23 is indicated by a one-dot chain line in FIG. 3. The carriage 23 moves to the right and left of the conveying path 65 in the left-right direction 9.

The ink tank 100 and the recording head 39 are connected by an ink tube 32. A control board on which a controller (not illustrated) is mounted and the recording head 39 are electrically connected by a flexible flat cable 33. The ink tube 32 and the flexible flat cable 33 extend from the carriage 23. The ink tube 32 supplies the ink stored in the ink tank 100 to the recording head 39. The flexible flat cable 33 transmits a control signal output from the controller to the recording head 39.

As illustrated in FIG. 2, the recording head 39 is mounted on the carriage 23. A plurality of nozzles 40 are located on a lower surface of the recording head 39. Hereinafter, the lower surface of the recording head 39 where the nozzles 40 are located may be referred to as a “nozzle surface”. The recording head 39 ejects ink (example of recording liquid) as minute ink droplets from the nozzle 40. In the course of movement of the carriage 23, the recording head 39 ejects ink droplets toward the sheet 12 supported by the platen 42. Thus, an image is recorded on the sheet 12.

### Platen 42

As illustrated in FIGS. 2 and 3, the platen 42 is located between the conveying roller part 54 and the discharge roller part 55 in the conveying orientation 16. The platen 42 faces the recording unit 24 in the up-down direction 7. The platen 42 supports, from below, the sheet 12 conveyed by the conveying roller part 54.

### Ink Tank 100

As illustrated in FIGS. 1A and 1B, the ink tank 100 is located inside the multi function device 10. The ink tank 100 is fixed to the multi function device 10 so as not to be easily detached from the multi function device 10. An opening 22 is formed in the front surface of the casing of the multi function device 10 at the right end in the left-right direction 9. The ink tank 100 is located behind the opening 22. A cover 70 is provided on the opening 22. The cover 70 is rotatable about a rotation axis extending in the left-right direction 9 on the lower end side in the up-down direction 7. The cover 70 rotates between a cover position (see FIG. 1A) where the opening 22 is covered and an expose position (see FIG. 1B) where the opening 22 is exposed to the outside of the multi function device 10.

The ink tank 100 includes four ink tanks 100B, 100Y, 100C, and 100M. The ink tank 100B stores black (B) ink. The ink tank 100Y stores yellow (Y) ink. The ink tank 100C stores cyan (C) ink. The ink tank 100M stores magenta (M) ink. The ink tanks 100B, 100Y, 100C, and 100M have the same configuration. Therefore, hereinafter, the configuration of the ink tank 100M will be described, and the description of the configurations of the other ink tanks 100B, 100Y, and 100C will be omitted.

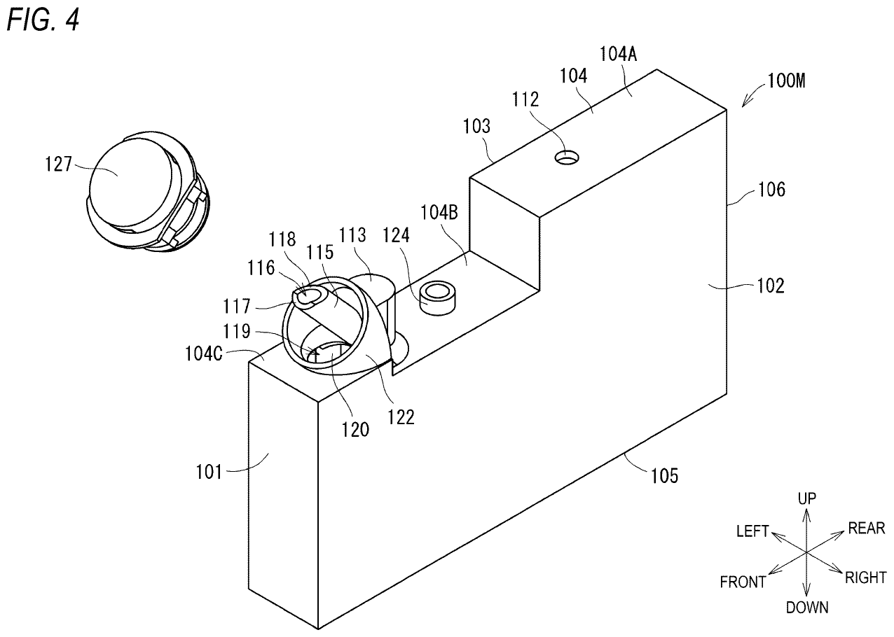

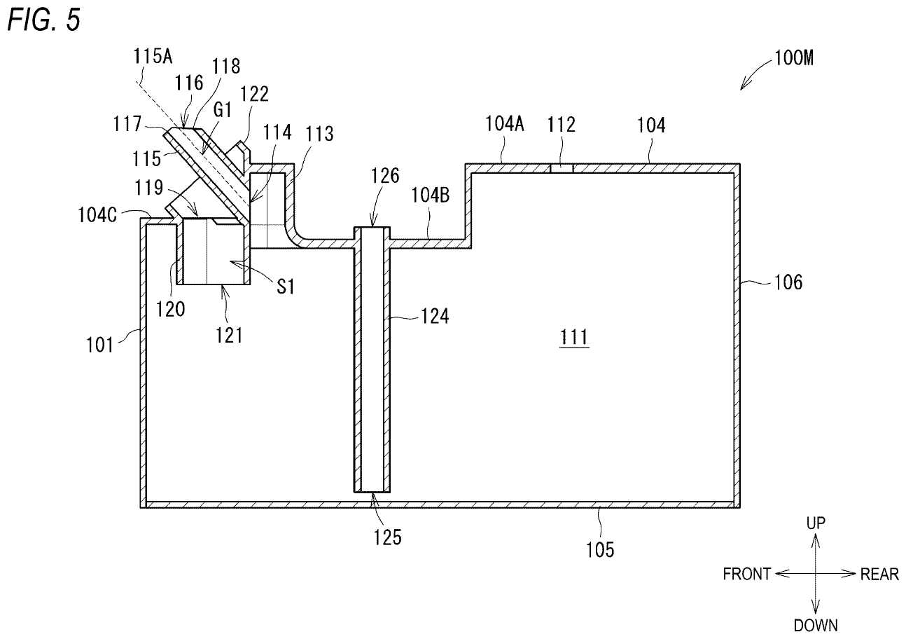

As illustrated in FIGS. 4 and 5, an outer shape of the ink tank 100M is a substantially rectangular parallelepiped. The ink tank 100 includes a front wall 101, a right wall 102, a left wall 103, an upper wall 104, a lower wall 105, a rear wall 106, a tank-side tube body 115, a third opening 119, a cover portion 122, and an outflow tube 124. The front wall 101, the right wall 102, the left wall 103, the upper wall 104, the lower wall 105, and the rear wall 106 define an ink chamber 111 (example of second storage chamber) in which ink is stored. The ink tank 100 is integrally molded by, for example, injection molding a resin material. Among outer walls of the ink tank 100, for example, the lower wall 105 may be another molded article. The front wall 101, the right wall 102, the left wall 103, the upper wall 104, the lower wall 105, and the rear wall 106 have translucency to such an extent that a liquid level of the ink inside the ink tank 100 can be visually recognized from the outside of the ink tank 100.

An upper surface of the upper wall 104 is a horizontal surface extending in the front-rear direction 8 and the left-right direction 9. The upper wall 104 includes a rear upper wall 104A, a middle upper wall 104B, and a front upper wall 104C. The rear upper wall 104A extends from a rear end of the upper wall 104 to a substantially center of the upper wall 104 in the front-rear direction 8. An upper surface of the rear upper wall 104A is located above an upper surface of the middle upper wall 104B and an upper surface of the front upper wall 104C. The rear upper wall 104A has an air communication port 112 that communicates the ink chamber 111 with the outside. The air communication port 112 penetrates the rear upper wall 104A in the up-down direction 7.

The middle upper wall 104B is located between the rear upper wall 104A and the front upper wall 104C in the front-rear direction 8. The middle upper wall 104B is located at a substantially center of the upper wall 104 in the front-rear direction 8. An upper surface of the middle upper wall 104B is located below the upper surface of the rear upper wall 104A. The middle upper wall 104B has a cylindrical upper bulging portion 113 extending in the upward orientation from the upper surface thereof. The upper bulging portion 113 is located at a front end portion of the middle upper wall 104B. An upper end of the upper bulging portion 113 is closed. An internal space of the upper bulging portion 113 is opened in the downward orientation. The upper bulging portion 113 has a first communication port 114 that communicates the internal space thereof with the outside. The first communication port 114 is circular. The first communication port 114 is an example of a fourth opening located in the second storage chamber.

The tank-side tube body 115 (example of second flow path part) is connected to the first communication port 114. The tank-side tube body 115 is a circular tube extending obliquely in the upward orientation from the first communication port 114 along an extending direction intersecting the gravity direction and the horizontal direction. The tank-side tube body 115 is circular when viewed in a tube axis direction. The tank-side tube body 115 has a second communication port 116 at a distal end thereof. The second communication port 116 is circular. The second communication port 116 is an example of a fifth opening located outside the second storage chamber. The tank-side tube body 115 defines an air flow path G1 (example of second flow path) connecting the first communication port 114 and the second communication port 116. The distal end of the tank-side tube body 115 has a pressing surface 117 and a horizontal surface 118. The pressing surface 117 is a surface parallel to a virtual plane orthogonal to a tube axis 115A (example of center line) of the tank-side tube body 115. The pressing surface 117 is located on the lower side at the distal end of the tank-side tube body 115. The pressing surface 117 is a surface that presses a valve 133 of the liquid bottle 80 when the liquid bottle 80 described later is connected to the ink tank 100M. The horizontal surface 118 is a horizontal surface. The horizontal surface 118 is located on the upper side at the distal end of the tank-side tube body 115. Thus, the second communication port 116 is opened in the upward orientation. The horizontal surface 118 may be slightly inclined with respect to the horizontal direction.

The front upper wall 104C extends from a front end of the upper wall 104 to a front end of the middle upper wall 104B. The upper surface of the front upper wall 104C is lower than the upper surface of the rear upper wall 104A and higher than the upper surface of the middle upper wall 104B. The third communication port 119 (example of sixth opening) communicating the ink chamber 111 with the outside is opened in the upper surface of the front upper wall 104C. The third communication port 119 penetrates the front upper wall 104C in the up-down direction 7. The third communication port 119 is adjacent to the front of the upper bulging portion 113. The third communication port 119 is located at a rear end portion of the front upper wall 104C. The third communication port 119 is circular. The connection tube body 120 (example of third flow path part) is connected to the third communication port 119. The connection tube body 120 is a circular tube extending in the downward orientation from the third communication port 119 in the ink chamber 111 along the gravity direction. An inner diameter of the connection tube body 120 is larger than an inner diameter of the tank-side tube body 115. The connection tube body 120 has, at a lower end thereof, a fourth communication port 121 (example of seventh opening) that is opened in the downward orientation. The fourth communication port 121 is located below the first communication port 114. The fourth communication port 121 is circular. The connection tube body 120 is a tube body that communicates with the bottle-side tube body 135 of the liquid bottle 80 when the liquid bottle 80 is connected to the ink tank 100M. The connection tube body 120 defines an auxiliary ink flow path S1 (example of third flow path).

The upper surface of the front upper wall 104C is provided with the cylindrical cover portion 122 that covers the tank-side tube body 115 and a periphery of the third communication port 119. The cover portion 122 extends, in parallel with the tank-side tube body 115, in the upward orientation from the front upper wall 104C and the upper bulging portion 113 along the extending direction intersecting the gravity direction and the horizontal direction. The tank-side tube body 115 protrudes in the upward orientation from a distal end of the cover portion 122. A tank cap 127 attachable to and detachable from the cover portion 122 is provided. FIG. 4 illustrates a state where the tank cap 127 is detached from the cover portion 122. The tank cap 127 is a cylindrical member having one closed end. The tank cap 127 is press-fitted to a distal end portion of the cover portion 122 to close the second communication port 116 and the third communication port 119 of the tank-side tube body 115. Accordingly, the tank cap 127 prevents a foreign matter such as dust from entering the ink tank 100M through the tank-side tube body 115 and the third communication port 119 and prevents ink from leaking from the ink tank 100M.

The outflow tube 124 has an outflow port 125 and a connection port 126. The outflow tube 124 is located on the middle upper wall 104B. The outflow tube 124 is located at a substantially center of the middle upper wall 104B in the front-rear direction 8. The outflow tube 124 is a circular tube extending in the up-down direction 7. The outflow tube 124 penetrates the middle upper wall 104B. A lower end of the outflow tube 124 is located in the vicinity of an upper surface of the lower wall 105. An opening at the lower end of the outflow tube 124 is the outflow port 125. An upper end portion of the outflow tube 124 is located outside the ink chamber 111. An opening at the upper end of the outflow tube 124 is the connection port 126. The ink tube 32 is connected to the connection port 126. The ink in the ink chamber 111 is supplied to the recording head 39 via the outflow tube 124 and the ink tube 32 during printing. When the ink in the ink chamber 111 is consumed by ejecting the ink from the recording head 39, air flows into the ink chamber 111 through the air communication port 112.

### Liquid Bottle 80

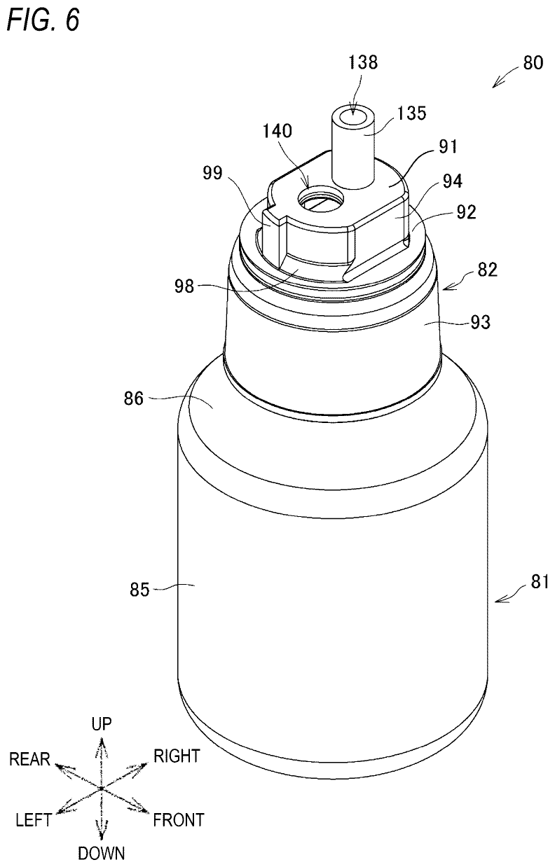

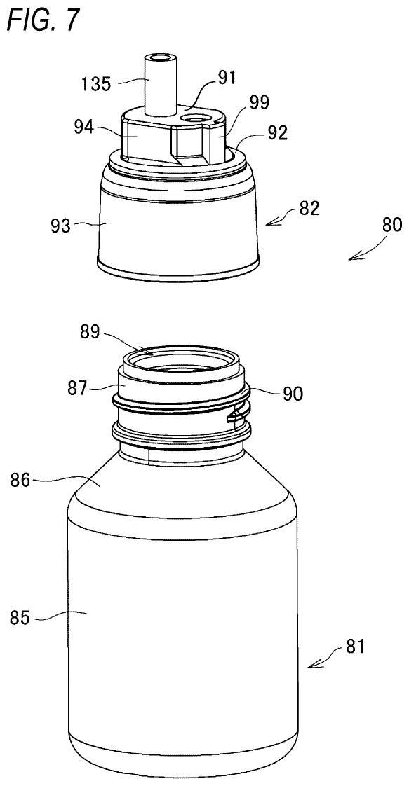

The liquid bottle 80 illustrated in FIGS. 6 to 8 is connected to the ink tank 100M and has a substantially cylindrical shape. The liquid bottle 80 includes a bottle body 81 (example of body) and the valve 133. Hereinafter, in the liquid bottle 80, the up-down direction 7 is defined based on a state where a bottom wall 84 described later is placed on a horizontal surface.

The bottle body 81 includes the bottom wall 84, a first side wall 85, a second side wall 86, a third side wall 87, and a bottle cap 82. The bottom wall 84 is a substantially circular wall. The first side wall 85 is a cylindrical wall extending in the upward orientation from an outer edge of the bottom wall 84. The second side wall 86 extends in the upward orientation from an upper end of the first side wall 85 while being inclined in a direction in which the bottle body 81 is reduced in diameter. The third side wall 87 is a cylindrical wall extending in the upward orientation from an upper end of the second side wall 86. The third side wall 87 has a male screw 90 on an outer peripheral surface thereof. The bottle cap 82 is an example of a port portion and a container cap. The third side wall 87 is an example of the port portion and an attachment portion.

A space defined by the bottom wall 84, the first side wall 85, the second side wall 86, and the third side wall 87 is an ink storage chamber 88 (example of first storage chamber). Ink is stored in the ink storage chamber 88. The third side wall 87 defines an opening 89 of the ink storage chamber 88. The ink storage chamber 88 communicates with the outside of the bottle body 81 through the opening 89.

The bottle cap 82 is attachable to and detachable from the third side wall 87. The bottle cap 82 includes a bottom wall 92, a fourth side wall 93, and a protrusion 94. The bottom wall 92 is a substantially annular wall. The fourth side wall 93 is a substantially cylindrical wall extending in the downward orientation from an outer peripheral edge of the bottom wall 92. The fourth side wall 93 has a female screw (not illustrated) on an inner peripheral surface thereof. The female screw is screwed with the male screw 90 of the bottle body 81. The bottle cap 82 is attached to the third side wall 87 by screwing the male screw 90 and the female screw.

The protrusion 94 is a cylindrical wall protruding in the upward orientation from an inner peripheral edge of the bottom wall 92. A front side and a rear side of the protrusion 94 have a planar shape extending in the up-down direction 7 and the left-right direction 9. A left side and a right side of the protrusion 94 are formed by curving flat plates extending in the up-down direction 7 and the front-rear direction 8. An internal space 96 of the protrusion 94 has a substantially elliptical shape elongated in the left-right direction 9 when viewed in the up-down direction 7. The protrusion 94 has an inclined portion 98 on the left side of a lower end portion thereof. When the protrusion 94 is viewed from the front, the inclined portion 98 is inclined such that the internal space 96 of the protrusion 94 extends in the leftward orientation as it goes downward. A space formed by combining the internal space 96 of the protrusion 94 and the ink storage chamber 88 is an example of the inside of the body.

The protrusion 94 has a key member 99 extending in the leftward orientation from a left portion of an outer peripheral surface thereof. The key member 99 extends from a lower end of the protrusion 94 to an upper end thereof. A protruding end of the key member 99 is located to the right of the outer peripheral edge of the bottom wall 92.

The protrusion 94 has an upper end wall 91 that separates the internal space 96 of the protrusion 94 from the outside, the bottle-side tube body 135, and a seventh communication port 140. The upper end wall 91 has the bottle-side tube body 135 and the seventh communication port 140. The bottle-side tube body 135 communicates the internal space 96 of the protrusion 94 with the outside of the bottle body 81. The bottle-side tube body 135 has a fifth communication port 137 and a sixth communication port 138. A lower end of the bottle-side tube body 135 is opened to the inside of the bottle body 81 by the fifth communication port 137. An upper end of the bottle-side tube body 135 is opened to the outside of the bottle body 81 by the sixth communication port 138. The sixth communication port 138, which is the upper end of the bottle-side tube body 135, is located downstream of the seventh opening 140 in the direction in which the bottle-side tube body 135 extends from the lower end toward the upper end. The fifth communication port 137, the sixth communication port 138, and the seventh communication port 140 are circular. The fifth communication port 137 is located to the right of the center of the protrusion 94 in the left-right direction 9. The bottle-side tube body 135 is a circular tube extending in the upward orientation from the fifth communication port 137 to the sixth communication port 138. The upper end wall 91 is orthogonal to the direction in which the bottle-side tube body 135 extends. The bottle-side tube body 135 defines an ink flow path F1 connecting the fifth communication port 137 and the sixth communication port 138. A diameter of the ink flow path F1 is equal to a diameter of the air flow path G1 defined by the tank-side tube body 115. The diameter of the ink flow path F1 may not be equal to the diameter of the air flow path G1. The upper end wall 91 is an example of a wall. The bottle-side tube body 135 is an example of a first flow path part. The fifth communication port 137 is an example of a first opening and a first end. The sixth communication port 138 is an example of a second opening and a second end. The seventh communication port 140 is an example of a third opening and a communication port. The ink flow path F1 is an example of a first flow path.

The seventh communication port 140 is located to the left of the bottle-side tube body 135. The seventh communication port 140 communicates the internal space 96 of the protrusion 94 with the outside of the bottle body 81. When the liquid bottle 80 is connected to the ink tank 100M, the seventh communication port 140 is an opening into which the tank-side tube body 115 is inserted.

The bottle-side tube body 135 is located to the right of the center of the protrusion 94 in the left-right direction 9. That is, the bottle-side tube body 135 is eccentric, with respect to the protrusion 94 or the bottle cap 82, in the left-right direction in which the bottle-side tube body 135 and the seventh communication port 140 are aligned.

The upper end wall 91 has a shape obtained by combining the shape of the key member 99 with a substantially elliptical shape elongated in the left-right direction when viewed in the up-down direction. The key member 99 protrudes in an orientation intersecting the up-down direction. That is, the upper end wall 91 is not rotationally symmetric when viewed in the up-down direction in which the bottle-side tube body 135 extends. The term “rotationally symmetric” means that an object overlaps twice or more when the object is rotated 360 degrees with the center of the object as a rotation axis. For example, in a case where the shape of the upper end wall 91 is an equilateral triangle, the upper end wall 91 overlaps three times when the upper end wall 91 is rotated by 360 degrees with the center of the upper end wall 91 as a rotation axis, and thus it can be said that the upper end wall 91 is rotationally symmetric with respect to the center of the upper end wall 91. In the present embodiment, the upper end wall 91 overlaps only once when the upper end wall 91 is rotated by 360 degrees about the center of the upper end wall 91 as the rotation axis, and thus the upper end wall 91 is not rotationally symmetrical with respect to the center of the upper end wall 91.

The valve 133 is located in the internal space 96 of the protrusion 94. The valve 133 includes a valve body 133A, a valve seat 133B, and a coil spring 133C. The valve body 133A has a flat plate shape extending in the front-rear direction 8 and the left-right direction 9. The valve body 133A has a substantially elliptical shape along an inner surface of the protrusion 94 when viewed in the up-down direction 7. An upper surface of the valve body 133A abuts against a lower surface of the upper end wall 91 of the protrusion 94. A length of the valve body 133A in the left-right direction 9 is a length for closing the fifth communication port 137 and the seventh communication port 140. The length of the valve body 133A in the left-right direction 9 is smaller than an inner diameter of the protrusion 94. The length of the valve body 133A in the front-rear direction 8 is a length at which a front end and a rear end of the valve body 133A slightly come into contact with the inner surface of the protrusion 94. The valve body 133A is movable in the up-down direction 7 along the inner surface of the protrusion 94.

The valve seat 133B is located below the valve body 133A. The valve seat 133B has a flat plate shape extending in the front-rear direction 8 and the left-right direction 9. The valve seat 133B is fixed to the inner surface of the protrusion 94 in the front-rear direction 8. The coil spring 133C is located between the valve body 133A and the valve seat 133B. The coil spring 133C is compressible in the up-down direction 7. The coil spring 133C is supported on an upper surface of the valve seat 133B. The coil spring 133C biases the valve body 133A in the upward orientation. Accordingly, the coil spring 133C presses the upper surface of the valve body 133A against the lower surface of the upper end wall 91 of the protrusion 94.

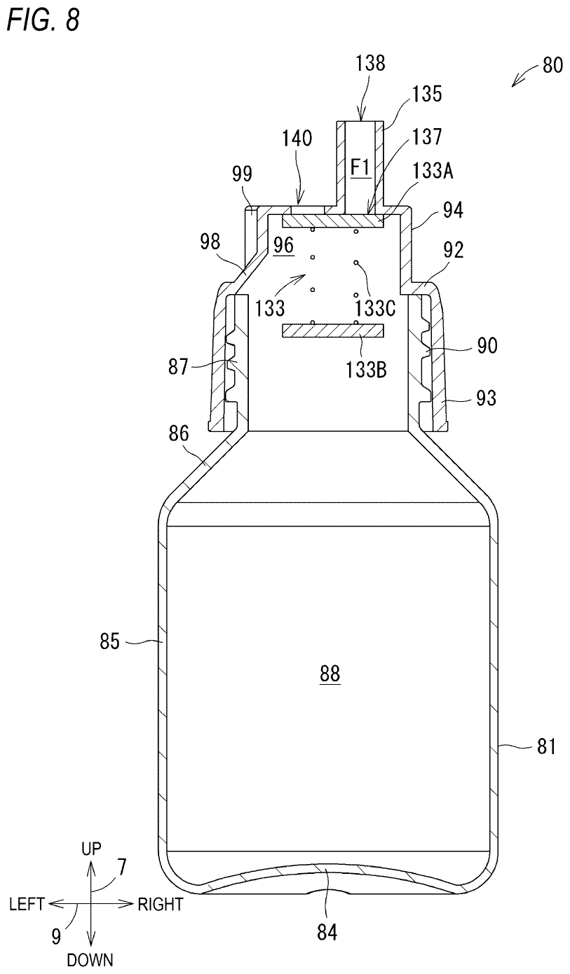

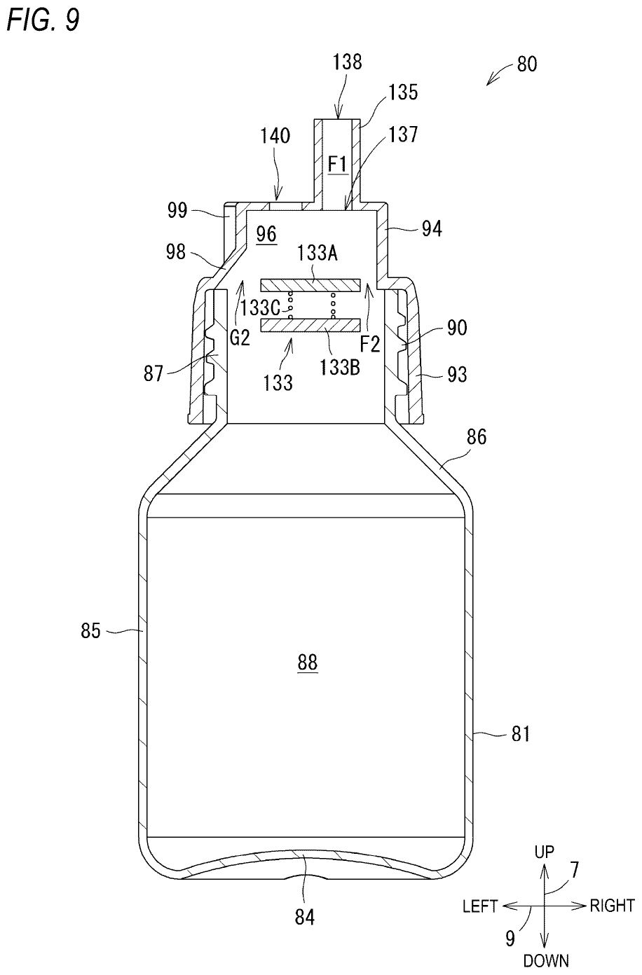

The valve 133 is movable between a close position and an open position along the up-down direction 7 in which the bottle-side tube body 135 extends. The close position is a position where the upper surface of the valve body 133A is pressed in the upward orientation against the lower surface of the upper end wall 91 of the protrusion 94 by a biasing force of the coil spring 133C (see FIG. 8). The valve body 133A at the close position closes the fifth communication port 137 and the seventh communication port 140 of the bottle-side tube body 135. The open position is a position where the valve body 133A is moved in the downward orientation from the close position against the biasing force of the coil spring 133C (see FIG. 9). The valve 133 at the open position defines, by a left end surface of the valve body 133A and an inner surface of the inclined portion 98, an air flow path G2 through which air flows. The air flow path G2 communicates the ink storage chamber 88 with the internal space 96 of the protrusion 94. The valve 133 at the open position defines, by a right end surface of the valve body 133A and the inner surface of the protrusion 94, an ink flow path F2 through which ink flows. The ink flow path F2 communicates the ink storage chamber 88 with the internal space 96 of the protrusion 94. The ink flow path F2 is smaller than the air flow path G2 in the left-right direction 9. In other words, the air flow path G2 is set to be larger than the ink flow path F2 by being defined by the left end surface of the valve body 133A and an inner surface of the inclined portion 98.

Connection with Ink Tank 100M of Liquid Bottle 80

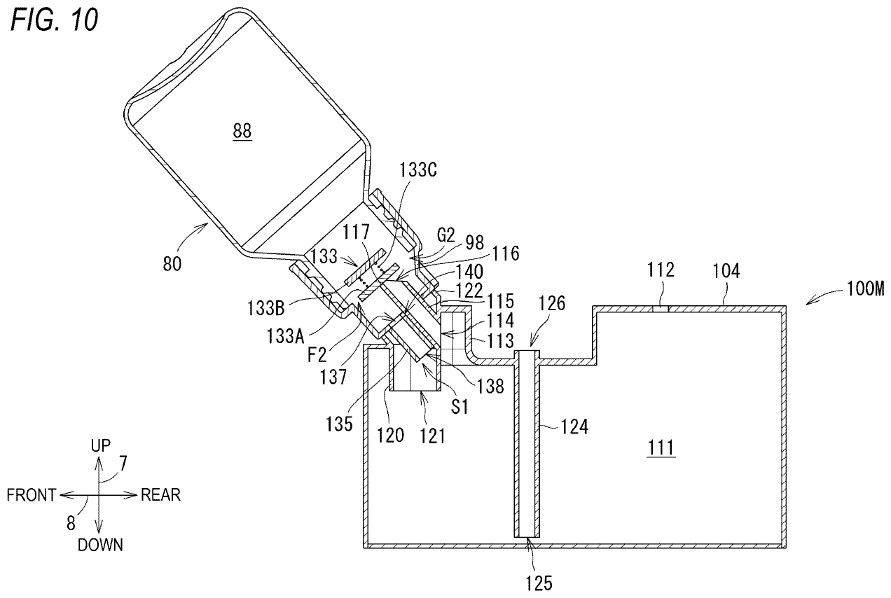

First, the tank cap 127 is detached from the cover portion 122 of the ink tank 100M. Next, as illustrated in FIG. 10, the bottle-side tube body 135 of the liquid bottle 80 is inserted into the third communication port 119 of the ink tank 100M, and the tank-side tube body 115 of the ink tank 100M is inserted into the seventh communication port 140 of the liquid bottle 80. At this time, the valve 133 is pressed obliquely in the upward orientation by the pressing surface 117 of the bottle-side tube body 135, thereby moving from the close position to the open position against the biasing force of the coil spring 133C. The bottle-side tube body 135 is connected to the connection tube body 120. As a result, the liquid bottle 80 is connected to the ink tank 100M, and the ink can be supplied to the inside of the ink tank 100M via the third opening 119. Hereinafter, the up-down direction 7 of the liquid bottle 80 will be described based on a connection posture when the liquid bottle 80 is connected to the ink tank 100M.

The bottle-side tube body 135 extends obliquely in the downward orientation along the extending direction intersecting the gravity direction and the horizontal direction. The bottle-side tube body 135 is located below the tank-side tube body 115. The fifth communication port 137 is located below the second communication port 116. The fifth communication port 137 is located below the seventh communication port 140. The fifth communication port 137 is located at a lower end of the internal space 96 of the protrusion 94. The air flow path G2 is located above the second communication port 116. The ink flow path F2 is located below the air flow path G2.

Hereinafter, the supply of ink from the liquid bottle 80 to the ink tank 100M when the liquid bottle 80 is in the connection posture will be described. In the following description, the ink is supplied from the liquid bottle 80 to the ink tank 100M by a so-called chicken feed method.

When the liquid bottle 80 is connected to the ink tank 100M, the sixth communication port 138 of the bottle-side tube body 135 is located in the ink chamber 111 of the ink tank 100, and the second communication port 116 of the tank-side tube body 115 is located in the internal space 96 of the protrusion 94 in the liquid bottle 80. Further, when the valve 133 is located at the open position, the air flow path G2 and the ink flow path F2 that communicate the ink storage chamber 88 with the internal space 96 of the protrusion 94 are formed. As a result, the ink storage chamber 88 of the liquid bottle 80 and the ink chamber 111 of the ink tank 100M communicate with each other through the ink flow path F2, the ink flow path F1, the auxiliary ink flow path S1, the air flow path G2, and the air flow path G1. Accordingly, the ink stored in the ink storage chamber 88 flows to the ink chamber 111 via the ink flow path F2, the ink flow path F1, and the auxiliary ink flow path S1. In addition, when the ink flows, the air enters the ink chamber 111 from the air communication port 112, and flows into the ink storage chamber 88 via the air flow path G1 and the air flow path G2. Here, a volume of the ink flowing from the ink storage chamber 88 to the ink chamber 111 is substantially the same as a volume of the air flowing from the ink chamber 111 to the ink storage chamber 88. In this way, so-called air-liquid replacement is performed. When all the ink in the ink storage chamber 88 of the liquid bottle 80 flows out to the ink chamber 111 of the ink tank 100, the air-liquid replacement ends. Finally, the liquid bottle 80 is detached from the ink tank 100M, and the tank cap 127 is attached to the cover portion 122 of the ink tank 100M.

### Operation and Effect of Embodiment

In the multi function device 10, since the liquid bottle 80 includes the bottle-side tube body 135, the bottle-side tube body 135 is likely to be submerged in the ink in the ink storage chamber 88 when the liquid bottle 80 is connected to the ink tank 100M. Therefore, when the bottle-side tube body 135 is inserted into the ink chamber 111 through the third communication port 119, the ink flow path F1 easily functions as a flow path through which the ink flows from the storage chamber to the ink chamber 111. On the other hand, when the liquid bottle 80 is connected to the ink tank 100, the tank-side tube body 115 is in an empty state. Therefore, when the tank-side tube body 115 is inserted into the internal space 96 of the protrusion 94 through the seventh communication port 140, the air flow path G1 easily functions as a flow path through which air flows from the ink chamber 111 to the ink storage chamber 88. Therefore, air-liquid exchange is smoothly performed in which the ink and air move back and forth between the liquid bottle 80 and the ink tank 100M. As a result, the ink is smoothly injected from the liquid bottle 80 into the ink tank 100M. Since the bottle-side tube body 135 functioning as a flow path through which the ink flows from the ink storage chamber 88 to the ink chamber 111 is formed in the liquid bottle 80, the ink easily flows into the bottle-side tube body 135 even when the amount of the ink in the liquid bottle 80 is small. Therefore, the ink is less likely to remain inside the liquid bottle 80.

In the multi function device 10, since when the liquid bottle 80 is connected to the ink tank 100M, the bottle-side tube body 135 is inserted into the ink chamber 111 through the third communication port 119, the ink in the ink storage chamber 88 is more reliably injected into the ink chamber 111 through the bottle-side tube body 135.

In the multi function device 10, the fifth communication port 137 is located below the second communication port 116 in a connection posture in which the liquid bottle 80 is connected to the ink tank 100. Therefore, the water pressure of the ink acting on the fifth communication port 137 is larger than the water pressure of the ink acting on the second communication port 116, and thus the bottle-side tube body 135 easily functions as a flow path through which the ink flows from the storage chamber to the ink chamber 111.

In the multi function device 10, since the fifth communication port 137 is located at a lower end of the internal space 96 of the protrusion 94 in the connection posture, the ink easily flows into the bottle-side tube body 135 even when the amount of the ink in the liquid bottle 80 decreases. Therefore, the ink is less likely to remain in the liquid bottle 80.

In the multi function device 10, the user easily connects the liquid bottle 80 to the ink tank 100 from the front of the ink tank 100. The bottle-side tube body 135 is located below the tank-side tube body 115 in the connection posture. Therefore, the water pressure of the ink acting on the fifth communication port 137 is larger than the water pressure of the ink acting on the second communication port 116, and thus the bottle-side tube body 135 functions as a flow path through which the ink flows from the storage chamber to the ink chamber 111. On the other hand, the tank-side tube body 115 functions as a flow path through which air flows from the ink chamber 111 to the ink storage chamber 88. Therefore, air-liquid exchange is smoothly performed in which the ink and air move back and forth between the liquid bottle 80 and the ink tank 100M.

In the multi function device 10, since the second communication port 116 is opened in the upward orientation in the connection posture, air easily flows from the second communication port 116 into the ink storage chamber 88 through the air flow path G2 located above the second communication port 116. Therefore, the tank-side tube body 115 easily functions as a flow path through which air flows from the ink chamber 111 to the ink storage chamber 88.

In the multi function device 10, since the liquid bottle 80 includes the valve 133 that closes the fifth communication port 137 and the seventh communication port 140 in the internal space 96 of the protrusion 94, the valve 133 prevents the ink from leaking from the ink storage chamber 88 to the outside before the user connects the liquid bottle 80 to the ink tank 100M. The valve 133 at the close position is pressed by the distal end of the tank-side tube body 115 inserted into the internal space 96 of the protrusion 94 through the seventh communication port 140, thereby moving to the open position where the fifth communication port 137 and the seventh communication port 140 are opened. Therefore, as compared with a case where a user needs to move the valve 133 from the close position to the open position separately from an operation of connecting the liquid bottle 80 to the ink tank 100M, the operation of injecting the ink from the liquid bottle 80 to the ink tank 100M is simple.

In the multi function device 10, the valve 133 at the close position is pressed by the pressing surface 117 parallel to a virtual plane orthogonal to the direction in which the tube axis 115A of the tank-side tube body 115 extends, and thus easily moves to the open position. The valve 133 and the tank-side tube body 115 are less likely to be damaged as compared with a case where the distal end of the tank-side tube body 115 is pointed.

In the multi function device 10, since the bottle-side tube body 135 is connected to the connection tube body 120 in the connection posture, a large water pressure acts on the fourth communication port 121 located at the lower end of the connection tube body 120. Therefore, the bottle-side tube body 135 and the connection tube body 120 easily function as a flow path through which the ink flows from the ink storage chamber 88 to the ink chamber 111. Therefore, air-liquid exchange is smoothly performed in which the ink and air move back and forth between the liquid bottle 80 and the ink tank 100M.

In the multi function device 10, the fourth communication port 121 is located below the first communication port 114. The ink flowing into the ink chamber 111 from the fourth communication port 121 flows in the downward orientation, and thus hardly reaches the first communication port 114 located above the fourth communication port 121. As a result, the ink flowing into the ink chamber 111 from the fourth communication port 121 is prevented from flowing back to the ink storage chamber 88 through the tank-side tube body 115.

The liquid bottle 80 has the bottle-side tube body 135, and thus is likely to be submerged by the ink in the liquid bottle 80 when connected to the tank. Therefore, the bottle-side tube body 135 easily functions as a flow path through which the ink flows from the liquid bottle 80 to the ink tank 100. In addition, since the upper end of the bottle-side tube body 135 in which the sixth communication port 138 is located is located downstream of the seventh communication port 140 in the direction in which the bottle-side tube body 135 extends from the lower end to the upper end, a water head difference is likely to occur. Therefore, air-liquid exchange is smoothly performed in which the ink and air move back and forth between the liquid bottle 80 and the ink tank 100. As a result, the ink is smoothly injected from the liquid bottle 80 into the ink tank 100. Since the liquid bottle 80 includes the bottle-side tube body 135, the ink easily flows into the bottle-side tube body 135 even when the amount of the ink in the liquid bottle 80 is small. Therefore, the ink is less likely to remain in the liquid bottle 80.

In the liquid bottle 80, the bottle-side tube body 135 is eccentric, with respect to the protrusion 94 or the bottle cap 82, in the left-right direction in which the bottle-side tube body 135 and the seventh communication port 140 are aligned. Therefore, in a case where the liquid bottle 80 is connected to the ink tank 100 in a state where the bottle-side tube body 135 is located below the seventh communication port 140, the ink easily flows into the bottle-side tube body 135 even when the amount of ink in the liquid bottle 80 is small. Therefore, the ink is less likely to remain in the liquid bottle 80.

In the liquid bottle 80, the valve 133 located inside the bottle body 81 is movable in the up-down direction in which the bottle-side tube body 135 extends, between a close position where the lower end of the bottle-side tube body 135 where the fifth communication port 137 is located and the seventh communication port 140 are closed and an open position where the lower end of the bottle-side tube body 135 and the seventh communication port 140 are opened. Therefore, supply of the ink to the outside of the liquid bottle 80 can be performed or stopped by the movement of the valve 133.

In the liquid bottle 80, the upper end wall 91 of the protrusion 94 has a shape that is not rotationally symmetric when viewed in the direction in which the bottle-side tube body 135 extends. Therefore, the orientation of the liquid bottle 80 when connected to the ink tank 100 is easily determined.

Since the liquid bottle 80 has the bottle-side tube body 135, the air-liquid exchange starts smoothly due to the occurrence of the water head difference.

### MODIFICATIONS

In the multi function device 10, the bottle-side tube body 135 is inserted into the third communication port 119 when the liquid bottle 80 is connected to the ink tank 100M, but may not be inserted into the third communication port 119 as long as the bottle-side tube body 135 can be connected to the third communication port 119. For example, the bottle-side tube body 135 may be located slightly above the third communication port 119 so that the ink flowing down from the sixth communication port 138 can flow into the ink chamber 111 through the third communication port 119 in a state where the liquid bottle 80 is connected to the ink tank 100M.

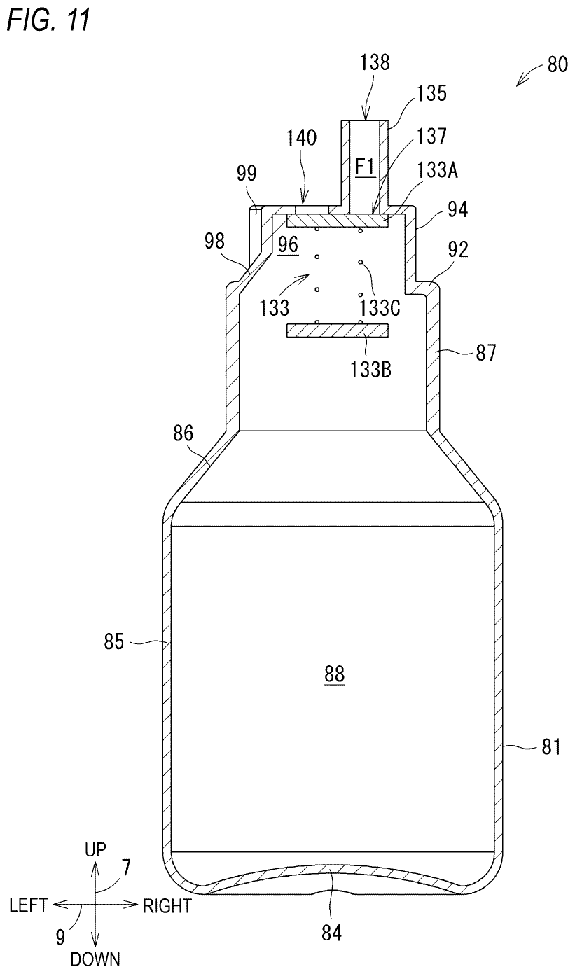

The third side wall 87 and the bottle cap 82 are separately formed, but may be integrally formed as illustrated in FIG. 11. In this case, the fourth side wall 93 of the bottle cap 82 may be omitted. The bottle body 81 in which the third side wall 87 and the bottle cap 82 are integrally formed is an example of the body. A side of the bottle body 81 in which the third side wall 87 and the bottle cap 82 are integrally formed, on which the fifth opening 137 and the seventh opening 140 communicate with each other, is an example of the port portion.

In the multi function device 10, the fifth communication port 137 is located below the second communication port 116 in the connection posture, but may be located above the second communication port 116 in the connection posture.

In the multi function device 10, the fifth communication port 137 is located at the substantially lower end of the liquid bottle 80 in the connection posture, but may be located above the lower end of the liquid bottle 80 in the connection posture.

In the multi function device 10, the bottle-side tube body 135 and the tank-side tube body 115 extend along the extending direction intersecting the gravity direction and the horizontal direction in the connection posture, but may extend along the gravity direction in the connection posture.

In the multi function device 10, the second communication port 116 is opened in the upward orientation in the connection posture, but the orientation of the second communication port 116 is not limited as long as air can flow into the internal space 96 of the protrusion 94 from the ink chamber 111 through the tank-side tube body 115. For example, the second communication port 116 may be opened in the downward orientation.

In the multi function device 10, the distal end of the tank-side tube body 115 has the pressing surface 117 parallel to the virtual plane orthogonal to the tube axis 115A of the tank-side tube body 115, but the pressing surface 117 may be omitted. In this case, the distal end of the tank-side tube body 115 may be pointed.

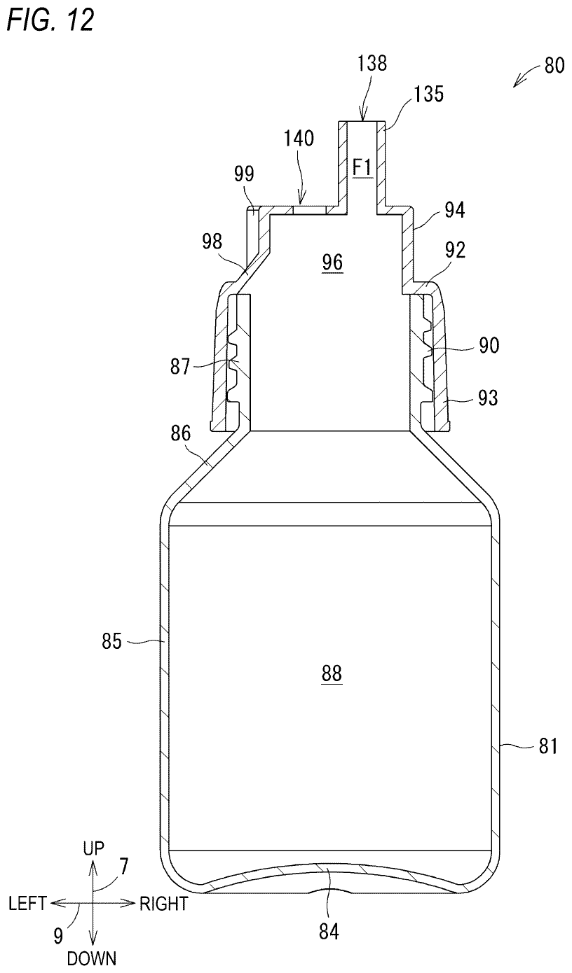

In the multi function device 10, the liquid bottle 80 has the valve 133 that closes the fifth communication port 137 and the seventh communication port 140 in the internal space 96 of the protrusion 94, but the valve 133 may be omitted as illustrated in FIG. 12.

In the multi function device 10, the connection tube body 120 extends in the downward orientation along the gravity direction, but the orientation in which the connection tube body 120 extends is not limited as long as the connection tube body 120 can be connected to the bottle-side tube body 135. For example, the connection tube body 120 may extend obliquely in the downward orientation from the third communication port 119 along a direction intersecting the gravity direction. In addition, the connection tube body 120 may be omitted.

In the multi function device 10, the fourth communication port 121 is located below the first communication port 114, but may be located above the first communication port 114.

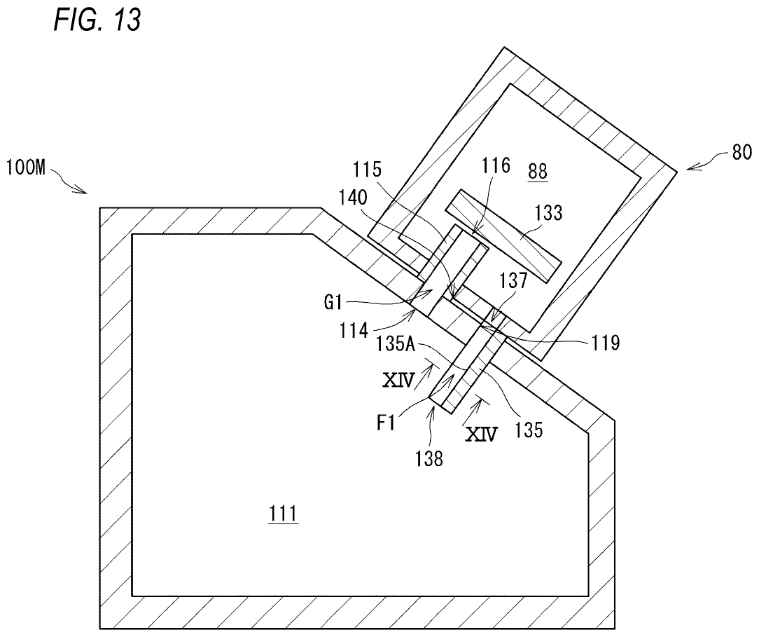

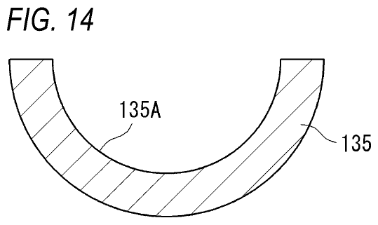

In the multi function device 10, the bottle-side tube body 135 has a circular shape when viewed in the tube axis direction, but may have an arc shape when viewed in the tube axis direction as illustrated in FIGS. 13 and 14. In this case, the fifth communication port 137 is located at a base end of the arc-shaped bottle-side tube body 135. The sixth communication port 138 is located at a distal end of the arc-shaped bottle-side tube body 135. When the arc-shaped bottle-side tube body 135 is inserted into the ink chamber 111 through the third communication port 119, the ink in the ink storage chamber 88 flows on the arc-shaped inner surface 135A of the bottle-side tube body 135 and flows into the ink chamber 111 in the connection posture.

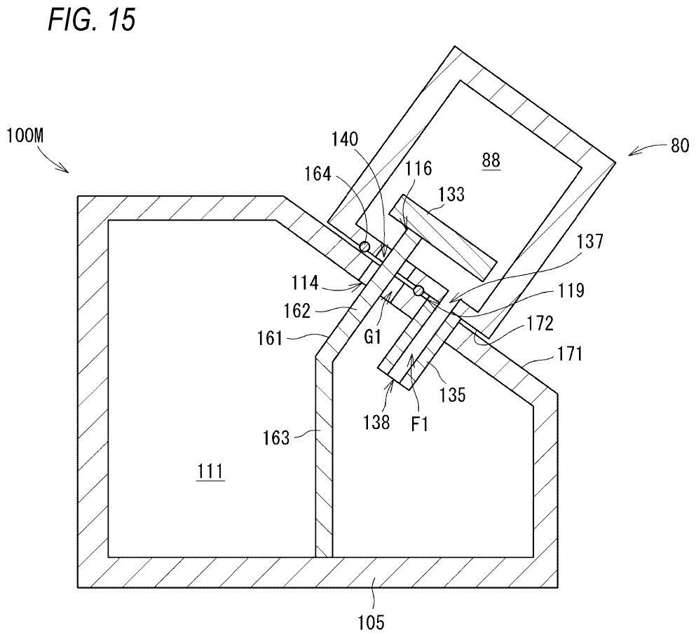

In the multi function device 10, the tank-side tube body 115 is a circular tube extending in the upward orientation from the first communication port 114 along the extending direction intersecting the gravity direction and the horizontal direction, but a rod-shaped push-up member 161 (example of second flow path part) extending from the ink chamber 111 to the outside of the ink chamber 111 through the first communication port 114 may be provided instead of the tank-side tube body 115, as illustrated in FIG. 15.

The push-up member 161 includes a push-up portion 162 extending obliquely in the upward orientation from the first communication port 114 along the extending direction intersecting the gravity direction and the horizontal direction, and a base portion 163 extending in the downward orientation from a lower end of the push-up portion 162 and fixed to the lower wall 105. A dimension of the push-up portion 162 in the direction orthogonal to the extending direction is smaller than the inner diameters of the first communication port 114 and the seventh communication port 140. The second communication port 116 is located around a distal end of the push-up portion 162. As illustrated in FIG. 15, the diameter of the seventh communication port 140 is larger than the diameter of the ink flow path F1. Therefore, it is easy to insert the push-up member 161 into the seventh communication port 140.

The push-up portion 162 is inserted into the seventh communication port 140 when the liquid bottle 80 is connected to the ink tank 100M. Accordingly, the push-up portion 162 defines the air flow path G1 connecting the first communication port 114 and the second communication port 116. At this time, the distal end of the push-up portion 162 presses the valve 133 obliquely in the upward orientation to move the valve 133 from the close position to the open position. As a result, the ink in the ink storage chamber 88 flows into the ink chamber 111 through the bottle-side tube body 135. Then, air flows from the ink chamber 111 into the ink storage chamber 88 along an outer surface of the push-up portion 162 in a gap between the push-up portion 162 and the first communication port 114 and the seventh communication port 140. In this case, a ring-shaped seal member 164 may be provided on an outer surface 171 of the ink tank 100M to which the first communication port 114 is opened so as to surround the first communication port 114. In the connection posture, the seal member 164 is in close contact with the outer surface 171 in which the first communication port 114 is opened and an outer surface 172 in which the seventh communication port 140 is opened. Accordingly, since the seal member 164 prevents air from flowing into the ink storage chamber 88 from the outside, air-liquid exchange is smoothly performed in which the ink and air move back and forth between the liquid bottle 80 and the ink tank 100M. The seal member 164 may be provided on the outer surface 172 of the liquid bottle 80 to which the seventh communication port 140 is opened.

Although the ink has been described as an example of the recording liquid, the present invention is not limited thereto. That is, instead of the ink, a pretreatment liquid to be ejected to the sheet prior to the ink during printing, water to be sprayed in the vicinity of the nozzle 40 of the recording head 39 to prevent the nozzle 40 of the recording head 39 from drying, or the like may be an example of the recording liquid.

According to the present specification, a system and a liquid container according to the following aspects are provided.
(1) A system according to the present disclosure including: a liquid container including a first storage chamber configured to store a recording liquid; and a tank including a second storage chamber configured to store the recording liquid, the liquid container being connected to the tank. The liquid container includes a first flow path part that defines a first flow path connecting a first opening located inside the liquid container and a second opening located outside the first storage chamber, and a third opening that communicates the first storage chamber with outside. The tank includes a second flow path part that defines a second flow path connecting a fourth opening located in the second storage chamber and a fifth opening located outside the second storage chamber and is inserted into the first storage chamber through the third opening from the outside, and a sixth opening that communicates the second storage chamber with the outside and is connected to the first flow path part.
When the liquid container is connected to the tank, the first flow path is likely to be submerged by the liquid in the first storage chamber. Therefore, when the first flow path part defining the first flow path is connected to the sixth opening, the first flow path easily functions as a flow path through which the liquid flows from the first storage chamber to the second storage chamber. On the other hand, when the liquid container is connected to the tank, the second flow path is in an empty state. Therefore, when the second flow path part defining the second flow path is inserted into the first storage chamber through the third opening, the second flow path easily functions as a flow path through which air flows from the second storage chamber to the first storage chamber. Therefore, air-liquid exchange is smoothly performed in which the liquid and air move back and forth between the liquid container and the tank. As a result, the liquid is smoothly injected from the liquid container into the tank. Since the first flow path that functions as a flow path through which the liquid flows from the first storage chamber to the second storage chamber is formed in the liquid container, the liquid easily flows into the first flow path even when the amount of liquid in the liquid container is small. Therefore, the liquid is less likely to remain in the liquid container.
(2) The first flow path part may be inserted into the sixth opening from the outside.
The liquid in the first storage chamber is more reliably injected into the second storage chamber through the first flow path part.
(3) The first opening may be located below the fifth opening in a connection posture in which the liquid container is connected to the tank.
Since a water pressure of the liquid acting on the first opening is higher than a water pressure of the liquid acting on the fifth opening, the first flow path easily functions as a flow path through which the liquid flows from the first storage chamber to the second storage chamber.
(4) The first opening may be located at a lower end of the liquid container in the connection posture.
The liquid easily flows into the first flow path even when the amount of liquid in the liquid container decreases. Therefore, the liquid is less likely to remain in the liquid container.
(5) The first flow path part may extend obliquely in a downward orientation from an outer wall of the liquid container along an extending direction intersecting with a gravity direction and a horizontal direction in the connection posture. The second flow path part may extend obliquely in an upward orientation from an outer wall of the tank along the extending direction. The first flow path part may be located below the second flow path part in the connection posture.
A user easily connects the liquid container to the tank from the front of the tank. Since a water pressure of the liquid acting on the first opening is higher than a water pressure of the liquid acting on the fifth opening, the first flow path easily functions as a flow path through which the liquid flows from the first storage chamber to the second storage chamber. The second flow path easily functions as a flow path through which air flows from the second storage chamber to the first storage chamber. Therefore, air-liquid exchange is smoothly performed in which the liquid and air move back and forth between the liquid container and the tank.
(6) The fifth opening may be opened in an upward orientation in the connection posture.
Since air easily flows into the first storage chamber from the fifth opening, the second flow path easily functions as a flow path through which air flows from the second storage chamber to the first storage chamber.
(7) The liquid container may include therein a valve located at a close position where the first opening and the third opening are closed. The valve at the close position may be pressed by a distal end of the second flow path part inserted into the liquid container through the third opening, thereby moving to an open position where the first opening and the third opening are opened.
Before the user connects the liquid container to the tank, leakage of the liquid from the first storage chamber to the outside is prevented by the valve. As compared with a case where the user needs to move the valve from the close position to the open position separately from an operation of connecting the liquid container to the tank, the operation of injecting the liquid from the liquid container to the tank is simple.
(8) The distal end of the second flow path part may include a pressing surface parallel to a virtual plane orthogonal to a direction in which a center line of the second flow path part extends.
Since the valve at the close position is pressed by the pressing surface parallel to the virtual plane orthogonal to the direction in which the center line of the second flow path part extends, the valve easily moves from the close position to the open position. The valve and the second flow path part are less likely to be damaged as compared with a case where the distal end of the second flow path part is pointed.
(9) The tank may include, in the second storage chamber, a third flow path part that defines a third flow path communicating with the first flow path in the connection posture. The third flow path part may extend in a downward orientation along the gravity direction and may include, at a lower end thereof, a seventh opening that is opened in the downward orientation.
Since the first flow path communicates with the third flow path in the connection posture, a large water pressure acts on the seventh opening. Therefore, the first flow path and the third flow path easily function as flow paths through which the liquid flows from the first storage chamber to the second storage chamber, so that air-liquid exchange is smoothly performed in which the liquid and air move back and forth between the liquid container and the tank.
(10) The seventh opening may be located below the fourth opening.
The liquid flowing into the second storage chamber from the seventh opening flows in the downward orientation, and thus hardly reaches the fourth opening located above the seventh opening. As a result, the liquid flowing into the second storage chamber from the seventh opening is prevented from flowing back to the first storage chamber through the second flow path.
(11) A liquid container according to the present disclosure connectable to a tank and capable of supplying a recording liquid to the tank, the liquid container including: a body configured to store the recording liquid; a first flow path part that communicates inside of the body with outside of the body and defines a first flow path connecting a first end opened to the inside and a second end opened to the outside; and a communication port that communicates the inside with the outside. The second end is located downstream of the communication port in a direction in which the first flow path part extends from the first end toward the second end.
The first flow path part includes the liquid container, and thus is likely to be submerged by the liquid in the liquid container when connected to the tank. Therefore, the first flow path part easily functions as a flow path through which the liquid flows from the liquid container to the tank. In addition, since the second end of the first flow path part is located downstream of the communication port in the direction in which the first flow path part extends from the first end toward the second end, a water head difference is likely to occur. Therefore, air-liquid exchange is smoothly performed in which the liquid and air move back and forth between the liquid container and the tank. As a result, the liquid is smoothly injected from the liquid container into the tank. Since the first flow path part includes the liquid container, the liquid easily flows into the first flow path part even when the amount of liquid in the liquid container decreases. Therefore, the liquid is less likely to remain in the liquid container.
(12) The body may include a port portion. The port portion may include the first flow path part and the communication port. The first flow path part is eccentric to the port portion in a direction in which the first flow path part and the communication port are aligned.
In a case where the liquid container is connected to the tank in a state where the first flow path part is located below the communication port, the liquid easily flows into the first flow path part even when the amount of the liquid in the liquid container decreases. Therefore, the liquid is less likely to remain in the liquid container.
(13) A valve located inside the body may also be provided. The valve may be movable in a direction in which the first flow path extends, between a close position where the first end and the communication port are closed and an open position where the first end and the communication port are opened.
Supply of the liquid to the outside of the liquid container can be performed or stopped by the movement of the valve.
(14) The port portion may include a container cap having the communication port, and an attachment portion to which the container cap is attached.
(15) The port portion may include a wall orthogonal to the direction in which the first flow path extends. The wall may include the first flow path part and the communication port.
(16) The wall may have a shape that is not rotationally symmetric when viewed in the direction in which the first flow path extends.
The orientation of the liquid container when connected to the tank is easily determined.
(17) The first flow path part may be a tube body.
Due to a water head difference, the air-liquid exchange starts smoothly.
(18) A diameter of the communication port may be larger than a diameter of the first flow path.
The second flow path part of the tank is easily inserted into the communication port.

With the system and the liquid container, the liquid is less likely to remain in the liquid container, and the liquid can be smoothly injected from the liquid container into the tank.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A system comprising:
a liquid container including a first storage chamber configured to store a recording liquid; and
a tank including a second storage chamber configured to store the recording liquid, the liquid container being connected to the tank, wherein
the liquid container includes a first flow path part that defines a first flow path connecting a first opening located inside the liquid container and a second opening located outside the first storage chamber, and a third opening that communicates the first storage chamber with outside, and
the tank includes a second flow path part that defines a second flow path connecting a fourth opening located in the second storage chamber and a fifth opening located outside the second storage chamber and is inserted into the first storage chamber through the third opening from the outside, and a sixth opening that communicates the second storage chamber with the outside and is connected to the first flow path part.

2. The system according to claim 1, wherein
the first flow path part is inserted into the sixth opening from the outside.

3. The system according to claim 1, wherein
the first opening is located below the fifth opening in a connection posture in which the liquid container is connected to the tank.

4. The system according to claim 3, wherein
the first opening is located at a lower end of the liquid container in the connection posture.

5. The system according to claim 4, wherein
the first flow path part extends obliquely in a downward orientation from an outer wall of the liquid container along an extending direction intersecting with a gravity direction and a horizontal direction in the connection posture,
the second flow path part extends obliquely in an upward orientation from an outer wall of the tank along the extending direction, and
the first flow path part is located below the second flow path part in the connection posture.

6. The system according to claim 4, wherein
the fifth opening is opened in an upward orientation in the connection posture.

7. The system according to claim 1, wherein
the liquid container includes therein a valve located at a close position where the first opening and the third opening are closed, and
the valve at the close position is pressed by a distal end of the second flow path part inserted into the liquid container through the third opening, thereby moving to an open position where the first opening and the third opening are opened.

8. The system according to claim 7, wherein
the distal end of the second flow path part includes a pressing surface parallel to a virtual plane orthogonal to a direction in which a center line of the second flow path part extends.

9. The system according to claim 1, wherein
the tank includes, in the second storage chamber, a third flow path part that defines a third flow path communicating with the first flow path in the connection posture, and
the third flow path part extends in a downward orientation along the gravity direction and includes, at a lower end thereof, a seventh opening that is opened in the downward orientation.

10. The system according to claim 9, wherein
the seventh opening is located below the fourth opening.

11. A liquid container connectable to a tank and capable of supplying a recording liquid to the tank, the liquid container comprising:
a body configured to store the recording liquid;
a first flow path part that communicates inside of the body with outside of the body and defines a first flow path connecting a first end opened to the inside and a second end opened to the outside; and
a communication port that communicates the inside with the outside, wherein
the second end is located downstream of the communication port in a direction in which the first flow path part extends from the first end toward the second end.

12. The liquid container according to claim 11, wherein
the body includes a port portion,
the port portion includes the first flow path part and the communication port, and
the first flow path part is eccentric to the port portion in a direction in which the first flow path part and the communication port are aligned.

13. The liquid container according to claim 12, further comprising:
a valve located inside the body, wherein
the valve is movable in a direction in which the first flow path extends, between a close position where the first end and the communication port are closed and an open position where the first end and the communication port are opened.

14. The liquid container according to claim 12, wherein
the port portion includes a container cap having the communication port, and an attachment portion to which the container cap is attached.

15. The liquid container according to claim 12, wherein
the port portion includes a wall orthogonal to the direction in which the first flow path extends, and
the wall includes the first flow path part and the communication port.

16. The liquid container according to claim 15, wherein
the wall has a shape that is not rotationally symmetric when viewed in the direction in which the first flow path extends.

17. The liquid container according to claim 11, wherein
the first flow path part is a tube body.

18. The liquid container according to claim 17, wherein
a diameter of the communication port is larger than a diameter of the first flow path.
